(19) United States
(12) Patent Application Publication
(10) Pub. No.: US 2025/0265503 A1
(43) Pub. Date: Aug. 21, 2025

(54) AI/ML FRAMEWORK FOR DISTRIBUTED APPLICATIONS AND FEDERATED LEARNING

(71) Applicant: ASG Networks Inc., Nashua, NH (US)

(72) Inventors: Murli Sivashanmugam, Bangalore (IN); Muzamil Karamadi, Bangalore (IN); Kaitki Agarwal, Westford, MA (US); Rajesh kumar Mishra, Westford, MA (US)

(21) Appl. No.: 19/059,176

(22) Filed: Feb. 20, 2025

Related U.S. Application Data
(60) Provisional application No. 63/556,121, filed on Feb. 21, 2024.

(51) Int. Cl. G06N 20/00

(52) U.S. Cl. CPC G06N 20/00

(57) ABSTRACT

A service node of a communication network may receive event data from one or more gateway components. The service node may process the event data to generate processed and transmit the processed data to a central location of the communication network. The central location may receive data from a plurality of other service nodes and train a machine-learning (ML) model using the processed data and received data from the plurality of other service nodes. The trained ML model may be deployed at the service node and used for performing various actions at the service node.

### CLAIM OF PRIORITY

This application claims the benefit of priority to U.S. Provisional Patent Application Ser. No. 63/556,121, filed on Feb. 21, 2024, and entitled “AIML Framework for Distributed Applications and Federated Learning,” which is incorporated herein by reference in its entirety.

### TECHNOLOGY FIELD

The present disclosure relates to telecommunications and network management technologies, specifically to dynamic network optimization using artificial intelligence (AI) and machine learning (ML) frameworks in distributed and federated learning environments.

### BACKGROUND

In today's rapidly evolving digital landscape, the demand for robust and efficient network connectivity is more important than in the past. As technologies such as 5G, 6G, IoT, and edge computing continue to advance, traditional network infrastructures are struggling to keep pace with the increasing complexity and dynamic nature of modern telecommunications. Conventional systems often rely on static configurations and manual interventions, which can lead to inefficiencies, increased operational costs, and an inability to adapt swiftly to changing network conditions. These challenges are further compounded by the need for seamless integration across diverse environments, including public and private clouds, as well as edge locations.

Existing network management solutions frequently fall short in addressing the multifaceted requirements of contemporary digital ecosystems. They often lack the flexibility to efficiently allocate resources and ensure optimal performance across distributed environments.

### SUMMARY

The present disclosure describes a method for operating a communication network, the method comprising: receiving, by a service node of the communication network, event data from one or more gateway components at the service node; processing the event data to generate processed data for transmission to a central location of the communication network, the processing comprising removing sensitive information and sampling the event data; transmitting, by the service node, the processed data to a central location, wherein the central location is configured to receive data from a plurality of other service nodes and to train a machine-learning (ML) model using the processed data and received data from the plurality of other service nodes, and wherein the central location is configured to deploy a ML model endpoint to the service node; extracting serving data from the event data; inputting the serving data into the ML model endpoint deployed at the service node from the central location; receiving a model output from the ML model endpoint; and processing the model output to perform an action at the service node.

The present disclosure also describes a system comprising at least one hardware processor; and at least one memory storing instructions that, when executed by the at least one hardware processor cause the at least one hardware processor to perform operations comprising: receiving, by a service node of the communication network, event data from one or more gateway components at the service node; processing the event data to generate processed data for transmission to a central location of the communication network, the processing comprising removing sensitive information and sampling the event data; transmitting, by the service node, the processed data to a central location, wherein the central location is configured to receive data from a plurality of other service nodes and to train a ML model using the processed data and received data from the plurality of other service nodes, and wherein the central location is configured to deploy a ML model endpoint to the service node; extracting serving data from the event data; inputting the serving data into the ML model endpoint deployed at the service node from the central location; receiving a model output from the ML model endpoint; and processing the model output to perform an action at the service node.

The present disclosure further describes a machine-storage medium embodying instructions that, when executed by a machine, cause the machine to perform operations comprising: receiving, by a service node of the communication network, event data from one or more gateway components at the service node; processing the event data to generate processed data for transmission to a central location of the communication network, the processing comprising removing sensitive information and sampling the event data; transmitting, by the service node, the processed data to a central location, wherein the central location is configured to receive data from a plurality of other service nodes and to train a ML model using the processed data and received data from the plurality of other service nodes, and wherein the central location is configured to deploy a ML model endpoint to the service node; extracting serving data from the event data; inputting the serving data into the ML model endpoint deployed at the service node from the central location; receiving a model output from the ML model endpoint; and processing the model output to perform an action at the service node.

### BRIEF DESCRIPTION OF FIGURES

Various ones of the appended drawings merely illustrate example implementations of the present disclosure and should not be considered as limiting its scope.

FIG. 1 is a schematic representation of an exemplary cloud system autonomous data and signaling traffic management in a distributed infrastructure, in accordance with some embodiments of the present disclosure.

FIG. 2A is a schematic representation of a cloud infrastructure for autonomous data and signaling traffic management in a distributed infrastructure, in accordance with some embodiments of the present disclosure.

FIG. 2B is a simplified block diagram of an example service node, in accordance with some embodiments of the present disclosure.

FIG. 3 is a flow diagram for a method for training and using a ML algorithm in distributed locations across a networked environment, in accordance with some embodiments of the present disclosure.

FIG. 4 shows a distributed AI/ML framework designed to facilitate efficient data processing, model training, and deployment across a networked environment, in accordance with some embodiments of the present disclosure.

FIG. 5 shows an example of an organization structure of data stored in a data lake at a central location, in accordance with some embodiments of the present disclosure.

FIG. 6 shows an anomaly detection use case scenario using the AI/ML framework, in accordance with some embodiments of the present disclosure.

FIG. 7 is a flow diagram for a method for traffic classification using the AI/ML framework, in accordance with some embodiments of the present disclosure.

FIG. 8 is a flow diagram for a method for network paging optimization using the AI/ML framework, in accordance with some embodiments of the present disclosure.

FIG. 9 is a flow diagram for a method for Tracking Area List optimization using the AI/ML framework, in accordance with some embodiments of the present disclosure.

FIG. 10A shows an example of static Tracking Area Lists.

FIG. 10B shows an example of optimized TAL configurations generated using the AI/ML framework, in accordance with some embodiments of the present disclosure.

FIG. 11 illustrates a diagrammatic representation of a machine in the form of a computer system within which a set of instructions may be executed for causing the machine to perform any one or more of the methodologies or techniques discussed herein, in accordance with some embodiments of the present disclosure.

### DETAILED DESCRIPTION

In the rapidly evolving landscape of digital communications, the demand for robust, efficient, and scalable network solutions has become more pressing. As network technology transitions into an era characterized by unprecedented connectivity and digital innovation, existing network infrastructures are increasingly strained under the weight of burgeoning data traffic and diverse user demands. The advent of wireless and wireline network requirements such as but not limited to 4G, 5G, 6G technologies, while promising transformative capabilities, such as enhanced data transfer rates and support for a wide array of applications, has highlighted significant challenges in current network management and operation. Traditional mobile networks, with their centralized architectures and manual management processes, struggle to meet the dynamic requirements of modern digital ecosystems, leading to inefficiencies and increased operational costs.

Network management practices often rely on static configurations and manual interventions, which are not well-suited to the dynamic and distributed nature of contemporary network environments. These conventional approaches are typically resource-intensive, requiring significant human oversight and specialized skills to manage complex network operations. Furthermore, the lack of integration with advanced technologies, such as artificial intelligence (AI) and machine learning (ML), limits the ability of these systems to adapt to changing network conditions and user demands. This results in suboptimal resource utilization, increased latency, and potential service disruptions, which are particularly problematic in scenarios requiring low latency and high bandwidth, such as autonomous vehicles, smart cities, and immersive virtual reality applications.

The present framework addresses these challenges by utilizing an autonomous network management that leverages AI and ML to optimize network operations across wireless and wireline connectivity. This framework provides a comprehensive solution that integrates AI/ML-driven automation, predictive analytics, and dynamic resource allocation to enhance network performance and efficiency. By employing a decentralized architecture, the framework enables seamless deployment across hybrid and multi-cloud environments, supporting both centralized and edge-based network functions. This approach not only reduces the need for manual intervention but also ensures that network resources are utilized effectively, thereby minimizing operational costs and improving overall service quality. The framework can adapt to evolving network conditions and user demands positions this approach as a future-ready solution capable of supporting the next wave of digital innovation and connectivity.

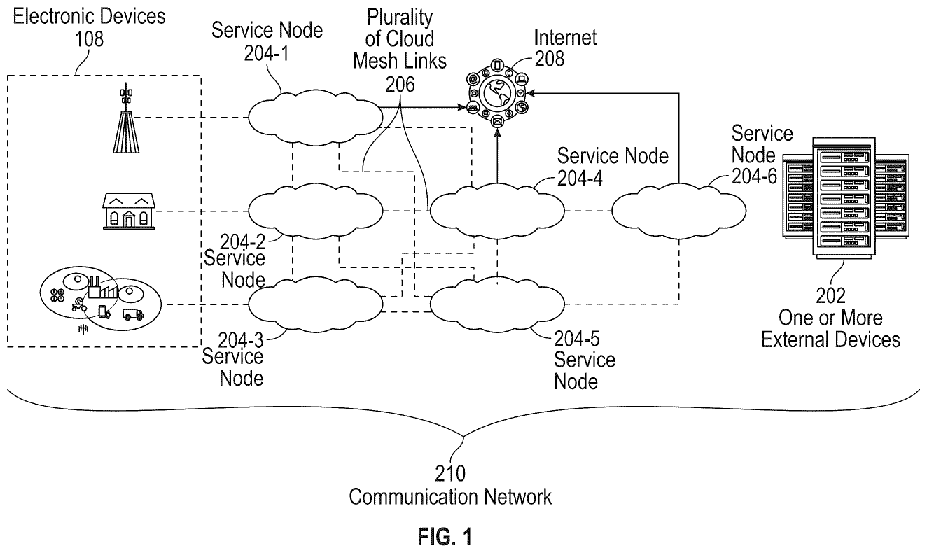

FIG. 1 is a schematic representation of an example of a cloud system autonomous data and signaling traffic management in a distributed infrastructure, in accordance with some embodiments of the present disclosure. The cloud infrastructure 200 includes one or more external devices 202 communicatively coupled to a plurality of service nodes 204-1, 204-2, 204-3, 204-4, 204-5 . . . 204-N via a transport network. For the sake of present description, the plurality of service nodes 204-1, 204-2, 204-3, 204-4, 204-5 . . . 204-N have been represented as the plurality of service nodes 204. In some embodiments of the present disclosure, the plurality of service nodes 204 may host a set of network functions including 4G, 5G, 6G or Wi-Fi network functions, such as Mobility Management Entity (MME), Signaling Gateway (SGW), Packet Gateway (PGW), Home Subscriber Server (HSS), Policy and Charging Rules Function (PCRF), Evolved Packet Data Gateway (ePDG), Trusted Wireless Access Gateway (TWAG), Centralized Unit (CU), Access & Mobility Management Function (AMF), Session Management Function (SMF), User Plane Function (UPF), Non-3GPP Interworking Function (N3IWF), Network Data Analytics Function (NWDAF), Network Repository Functions (NRF), Network Slicing Selection Function (NSSF), Network Exposure Function (NEF), Unified Data Management (UDM), Authentication Server Function (AUSF), Point Coordination Function (PCF) and the like. In some embodiments, the one or more external devices 202 may include one or more local servers, one or more cloud servers, compute nodes, content data network, internet, the set of network functions, one or more proxy servers and the like. The one or more external devices 202 are configured to host one or more services accessible by the plurality of service nodes 204.

Further, each of the plurality of service nodes 204 may act as a computing system including a plurality of modules to handle various functionality, as described herein. In some embodiments of the present disclosure, the one or more data centers may correspond to private cloud, public cloud, hybrid cloud and the like. Furthermore, the plurality of service nodes 204 are connected with each other via a plurality of cloud mesh links 206. The plurality of cloud mesh links 206 are secured ad hoc routing connections, such as Open Shortest Path First (OSPF) and the like between the plurality of service nodes 204. In some embodiments of the present disclosure, the plurality of service nodes 204 may include multiple physical parameters characterizing the plurality of service nodes 204 and compute one or more system parameters, such as energy requirement, power utilization, processing type, processing power, configuration and the like. Further, each of the plurality of service nodes 204 may have their own state information and characteristics, such as delay, jitter, packet flow information, protocol parameter information, quality of experience and the like, known as one or more network function parameters. In some embodiments of the present disclosure, one or more external inputs or parameters are received by a computing system via internet 208. Furthermore, the one or more system parameters, the one or more network function parameters and the one or more external inputs or parameters are one or more computing system parameters.

In some embodiments of the present disclosure, the service node 204-1, the service node 204-2 and the service node 204-3 are far edge clouds at first level of hierarchy within the cloud infrastructure 200. The first level of hierarchy corresponds to a first proximal distance from the one or more electronic devices 108. Further, the service node 204-4 and the service node 204-5 are regional edge clouds at second level of hierarchy within the cloud infrastructure 200. In some embodiments of the present disclosure, the second level of hierarchy corresponds to a second proximal distance from the one or more electronic devices 108. In some embodiments of the present disclosure, the service node 204-6 is closer to the one or more external devices 202. The service node 204-6 is at third level of hierarchy within the cloud infrastructure 200. In some embodiments of the present disclosure, the third level of hierarchy corresponds to a third proximal distance from the one or more electronic devices 108. In some embodiments of the present disclosure, the one or more external devices 202 may be main data center. In some embodiments of the present disclosure, each of the plurality of service nodes 204 is connected to the internet 208, as shown in FIG. 1.

Further, the cloud infrastructure 200 includes one or more orchestrator nodes connected to the plurality of service nodes 204 via a set of cloud mesh links. In some embodiments of the present disclosure, each of the one or more orchestrator nodes is an instance of a collective group of network functions hosted on the one or more data centers.

Furthermore, the cloud infrastructure 200 includes one or more electronic devices 108 associated with an organization connected to a communication network 210 via a communication channel. In some embodiments of the present disclosure, the communication network 210 may be private network, public network, smart city network, connected car network, Fixed Wireless Access (FWA) and the like. In some embodiments of the present disclosure, the one or more electronic devices 108 are connected to the plurality of service nodes 204. The one or more electronic devices 108 may be used by one or more users associated with the organization to access the communication network 210 for accessing one or more services hosted on the internet 208. In some embodiments of the present disclosure, the one or more external devices 202 are located nearby to the organization. In some embodiments of the present disclosure, the one or more electronic devices 108 may include a laptop computer, desktop computer, tablet computer, smartphone, wearable device, smart watch and the like. In some embodiments of the present disclosure, the one or more electronic devices 108 may also include a microprocessor, a server and the like. Further, the one or more electronic devices 108 include a local browser, a mobile application or a combination thereof. The one or more users may use a web application via the local browser, the mobile application or a combination thereof to communicate with the computing system. In some embodiments of the present disclosure, the one or more electronic devices 108 may access the computing system via a radio access network.

In some embodiments of the present disclosure, the computing system receives a request from the one or more electronic devices 108 within the communication network 210 to access the one or more services hosted on the one or more external devices 202 or a set of services hosted on the internet 208. Further, the computing system determines one or more network parameters based on the received request, one or more device parameters and the one or more computing system parameters by using a trained Machine Learning (ML) model. The computing system also determines current network demand within the cloud infrastructure 200 based on the received request by using the trained based ML model. The computing system determines one or more service nodes at multiple levels of hierarchy within the cloud infrastructure 200 from the plurality of service nodes 204 based on the determined one or more network parameters and the determined current network demand by using the trained ML model. In an embodiment of the present disclosure, the one or more service nodes at first level of hierarchy within the cloud infrastructure 200 are service node 204-1, service node 204-2 and service node 204-3, service node 204-4, service node 204-5 and service node 204-6. Furthermore, the computing system dynamically establishes one or more cloud mesh links between the determined one or more service nodes 204-1, 204-2, 204-3, 204-4, 204-5 and 204-6 at the multiple levels of hierarchy and the one or more external devices 202 based on the determined one or more network parameters and the current network demand by using the trained ML model. The multiple levels of hierarchy comprise first level, second level, third level of hierarchy and the like. The computing system processes the received request by providing access of the one or more services hosted on the one or more external devices 202 to the one or more electronic devices 108 via the established one or more cloud mesh links.

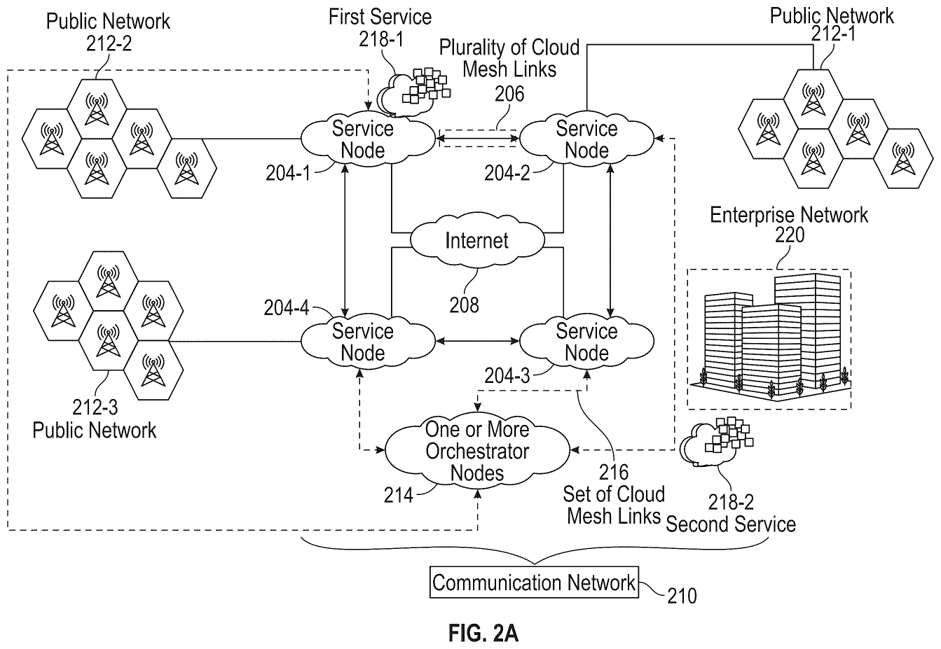

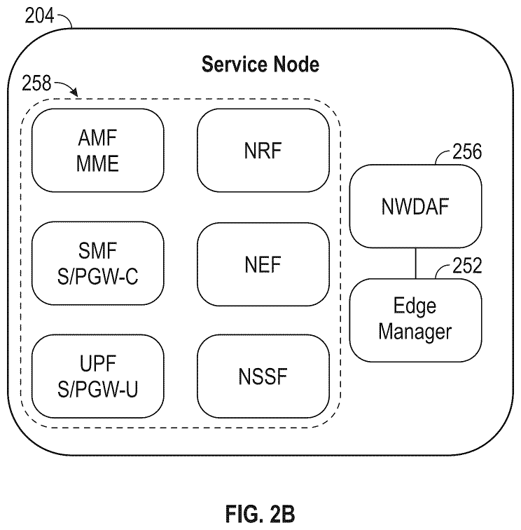

FIG. 2A is a schematic representation of a cloud infrastructure 200 for autonomous data and signaling traffic management in a distributed infrastructure, in accordance with some embodiments of the present disclosure. The cloud infrastructure 200 includes the plurality of service nodes 204-1, 204-2, 204-3 and 204-4. For the sake of present description, the plurality of service nodes 204-1, 204-2, 204-3 and 204-4 have been represented as the plurality of service nodes 204. The service node 204-3 is an enterprise cloud associated with the organization. Further, the service node 204-4 is a far edge cloud located at a distant position from the organization. The cloud infrastructure 200 includes the one or more electronic devices 108 associated with the organization connected to the communication network 210 via the communication channel. In some embodiments of the present disclosure, the communication network 210 is a 4G, 5G, 6G and WiFi network with the set of network functions including multiple 4G, 5G, 6G and WiFi network functions running on variety of cloud and compute infrastructures. Furthermore, the cloud infrastructure 200 includes a first public network 212-1, a second public network 212-2 and a third public network 212-3 to communicatively couple the one or more external devices 202 to the plurality of service nodes 204. In some embodiments of the present disclosure, the second public network 212-2 is shorter public network. The plurality of service nodes 204 are connected with each other via the plurality of cloud mesh links 206 and the internet 208. Further, the one or more orchestrator nodes 214 are connected to the plurality of service nodes 204 via a set of cloud mesh links 216. The one or more external devices 202 host a first service 218-1 and a second service 218-2 accessible by the plurality of service nodes 204. In some embodiments of the present disclosure, the plurality of service nodes 204 may also be communicatively coupled with one or more operator networks to achieve seamless integration of the one or more electronic devices 108 with the one or more operator networks.

In some embodiments of the present disclosure, the computing environment 200 is applicable in telecommunication, healthcare, manufacturing, transport, public safety domains and the like. As described above, the computing environment 200 includes the plurality of service nodes 204-1, 204-2, 204-2 and 204-4. For the sake of present description, the plurality of service nodes 204-1, 204-2, 204-3 and 204-4 have been represented as the plurality of service nodes 204. The service node 204-3 is an enterprise cloud associated with the organization. Further, the service node 204-4 is a far edge cloud located at a distant position from the organization. The computing environment 200 includes one or more electronic devices 108 associated with the organization connected to the enterprise network 220 via the private communication channel. In some embodiments of the present disclosure, the enterprise network is a 4G or 5G or 6G or WiFi network and the like. Furthermore, the computing environment includes a first public network 206-1, a second public network 206-2 and a third public network 206-3 to communicatively couple the one or more external devices 202 to the plurality of service nodes 204. In some embodiments of the present disclosure, the second public network 206-2 is shorter public network. The plurality of service nodes 204 are connected with each other via the network 212 and internet 224. Further, the one or more orchestrator nodes 214 are connected to the plurality of service nodes 204 via the network 212. In some embodiments of the present disclosure, the network 212 may be the one or more cloud mesh links. The one or more external devices 202 host a first public network application 226-1 and a second public network application 226-2 accessible by the plurality of service nodes 204.

FIG. 2B is a simplified block diagram of an example service node 204, in accordance with some embodiments of the present disclosure. Service node 204 may include an edge manager 252, a network data analytics function (NWDAF) 256, and shared slice components 258. The shared slice components 258 may include any network function including 4G, 5G, 6G or Wi-Fi network functions, such as Access & Mobility Management Function (AMF), Mobility Management Entity (MME), Signaling Gateway (SGW), Packet Gateway (PGW), Home Subscriber Server (HSS), Policy and Charging Rules Function (PCRF), Evolved Packet Data Gateway (ePDG), Trusted Wireless Access Gateway (TWAG), Centralized Unit (CU), Session Management Function (SMF), User Plane Function (UPF), Non-3GPP Interworking Function (N3IWF, Network Repository Functions (NRF), Network Slicing Selection Function (NSSF), Network Exposure Function (NEF), Unified Data Management (UDM), Authentication Server Function (AUSF), Point Coordination Function (PCF) and the like.

The edge manager 252 may facilitate interactions with other service nodes and networks, such as private networks and other public networks. The edge manager 252 may communicate with other service nodes (and their respective edge managers) using a communication interface, such as a Cloud Mesh link. The communication interface may be based on webservices, for example, REST based webservices. Edge managers may act as routing agents. In some embodiments, edge managers may take the role of one or more network functions such as S1 proxy, NgAP proxy, Mobility Management Entity (MME), Signaling Gateway (SGW), Packet Gateway (PGW), Access & Mobility Management Function (AMF), Session Management Function (SMF), User Plane Function (UPF), Non-3GPP Interworking Function (N3IWF), Network Repository Functions (NRF), Network Slicing Selection Function (NSSF), Network Exposure Function (NEF) and the like.

The NWDAF 256 may collect usage data, analyze the usage data for network slices, and generate predicted usage information regarding resources, as described in further detail herein. The NWDAF 256 may execute machine-learning algorithms, as described herein. The NWDAF 256 may continuously analyze the parameters of each network slice and predict the usage or congestion that may occur at a future time. The prediction results as well as other data may be exchanged via a cloud mesh link with other service nodes.

Service nodes 204 may be provided as public and/or private networks or a combination thereof. For example, as explained in detail below, a service node 204 may be provided as a public network but may provide network slices for a private network in accordance with the dynamic network slice management techniques described herein. Likewise, for example, a service node 204 may be provided as a private network but may provide network slices for a public network in accordance with the dynamic network slicing techniques described herein.

Network slice management performed by service nodes enables multiple isolated and independent virtual (logical) networks to exist together. In other words, a plurality of virtual networks, i.e., slices, may be created using resources of the same physical network infrastructure. A slice includes shared network components that provides end-to-end connection enabling multiplexing of virtualized and independent logical networks using logical separation. In some embodiments, each network slice may be based on a set of parameters that are part of the SLA of the slice. For example, the set of parameters may include minimum guaranteed bandwidth, maximum end-to-end latency for data packets, guaranteed quality-of-service (QOS), simultaneous maximum number of users, and so on.

Service nodes 204 may be provided in the same or different edge locations. In some embodiments, a network slice may be managed at each edge location. Resources available at each edge location may be limited, and, therefore, these edge locations may not have endless resources to statically provision each slice and provide the guaranteed SLA.

In some embodiments, machine-learning algorithms may be used for various operations in a mesh network of service nodes located at one or more edge locations, such as dynamic network slicing management, anomaly detection, traffic classification, mobile network paging optimization, tracking area list (TAL) optimization, Discontinuous Reception (DRX) silence period prediction, UE radio context optimization, handover optimization, intelligent application-edge selection, abnormal activity detection (e.g., for IoT), and efficient microservice resource management. For example, the edge locations may be at different geographic locations, though service nodes may be connected in a mesh network or other suitable types of network configuration. In some embodiments, the machine-learning algorithm executed used for predicting various operations and may include linear regression algorithm, decision tree algorithm, time series analysis, K-means clustering, etc. In some embodiments, neural network-based machine-learning algorithm, such as artificial neural network (ANN) and/or recurrent neural network (RNN), etc., may also be used. The AI/ML algorithms may be executed using suitable processing architectures. For example, the AI/ML algorithms may be executed using a processing architecture including different types and combinations of processing units, such as Central Processing Unit (CPU), Graphics Processing Unit (GPU), Data Processing Unit (DPU), Tensor Processing Unit (TPU), etc.

In some examples, the ML algorithms may be deployed in a distributed manner in the service node locations, as described above, but may be trained at a centralized location. The centralized location may collect data from the various service node locations and may train and update the model with the collected data from the different locations. The trained and updated models may then be deployed to at the service node locations to perform various operations, as descried herein. This distributed and federated framework allows fast, autonomous decisions to be made at the service node locations using the locally-deployed ML algorithms while training the ML algorithms with more data from the distributed locations, improving the accuracy of the ML algorithms.

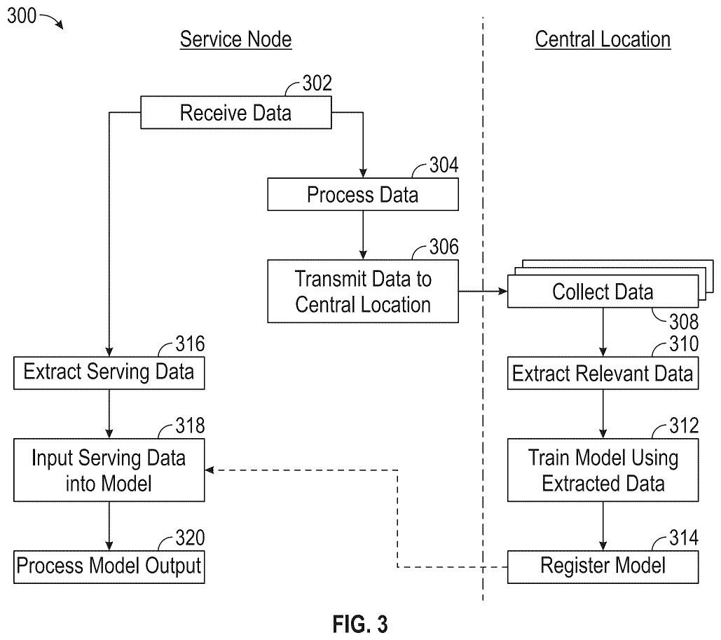

FIG. 3 is a flow diagram for a method 300 for training and using a ML algorithm in distributed locations across a networked environment, in accordance with some embodiments of the present disclosure. Portions of the method 300 are performed at a distributed location, such as a service node as described herein, and other portions are performed at a central location, such as an orchestrator node as described herein.

At operation 302, data is received at a service node. In some examples, the data may be received from gateway components. The gateway components may include different network functions, such as AMF, SMF, UPF. The data may include published events from the network functions, such as mobility events, session events, data events, etc. The received data is used for training a ML model as well as using a locally-deployed ML model to perform a particular operation, such as dynamic network slicing management, anomaly detection, traffic classification, mobile network paging optimization, TAL optimization, DRX silence period prediction, UE radio context optimization, handover optimization, intelligent application-edge selection, abnormal activity detection (e.g., for IoT), and efficient microservice resource management.

The model training will be described first. At operation 304, the data is processed for transmission to the central location. The processing may include signal processing, such as filtering, aggregating, and sampling. For example, the received data may include hundreds of mobility events collected during a session. Transmitting all mobility events may be cumbersome and consume significant bandwidth. Therefore, a portion of the mobility events, such as 10%, may be sampled for transmission. The sampled events may undergo other processing, such as removal of sensitive information, such as personal identification information (PII).

At operation 306, the processed data is transmitted from the service node to the central location. In some examples, the data may be transmitted using cloud mesh links as described herein. In some examples, continuous data transfer may be avoided. For example, batch data transfer may be utilized instead of single data transfer. The number of events per batch of data may be configurable. The processed data may be pushed from the edge location (service node) to the central location via SFTP. In some examples, sensitive information (e.g., IP addresses) may be masked before transmission. For example, sensitive information may be anonymized before being pushed to the central location.

At operation 308, the received data from the service node may be collected at the central location. The central location may also receive data from other service nodes in the network. The central location may store the collected data from the different distributed location in a database, such as a data lake. The collected data include raw data from the various sources and stored in a centralized repository in structured, semi-structured, or unstructured format.

At operation 310, relevant data may be extracted for a particular ML model that is to be trained. As mentioned above, the collected data include raw data from the different sources. Training a ML model with all the collected data from the distributed location would consume significant resources, such as processing resources and time, and may not lead to an accurate ML model. Thus, relevant data for the particular ML model may be extracted for ML model training to conserve resources and increasing accuracy of the ML model. For example, data extracted for an anomaly detection model may be different than the data extracted for a traffic-classification model. The extracted data may be customized for the corresponding model.

At operation 312, the model is trained using the extracted data. The ML model may include one or more of linear regression algorithm, decision tree algorithm, time series analysis, K-means clustering, etc. The ML model may include ANN, RNN, or other types of neural networks. For example, the ML model may be provided as a multi-layered machine learning model. For example, the ML model may include a plurality of observable layers with a plurality of hidden layers, such as an input layer, a feature extraction layer, a features relationship layer, and a decision layer. The extracted data may be sent to the input layer. The ML model may, in an iterative fashion, train its biases and coefficients in its layers. The decision layer may output a decision regarding the particular operation, such as the presence or absence of an anomaly. The training of the ML model may be a supervised and/or unsupervised process. For example, in a supervised process, labels for anomaly or no anomaly may be added to the extracted data. The labels may then be set as reference outputs. The ML model may adjust its biases and coefficients in its layers to generate an output for each set of extracted data substantially matching its respective reference output (e.g., anomaly or no anomaly). The ML model training may include hyperparameter tuning, cross-validation, and model selection.

At operation 314, the trained model is registered in a model registry. For example, the trained model is stored in a model database. The trained model may be an updated or new version of a prior model. The model database may store different types of models that have been trained at the central location. The registered model may then be deployed at the different distributed locations (e.g., service nodes). For example, the updated or newer version of the model may be transmitted and installed at the distributed locations. The model registry may maintain version control of the trained models, allowing for rollback to previous versions if needed.

Next, using the trained model at the distributed location is described. At operation 316, serving data for the particular model is extracted from the received data (e.g., from operation 302) at the service node. Different models may use different serving data for operation. For example, for a traffic-classification model, the serving data may include metadata for the first thirty packets in a session received from the UPF. The first thirty packets may form a packet signature of the traffic type.

At operation 318, the serving data is inputted into the deployed model in the service node. The model may generate a prediction output based on the serving data. In a traffic classification scenario, the output may be a traffic type. In an anomaly detection scenario, the output may be the presence or absence of an anomaly. In a network paging optimization scenario, the output may be a predicted location of the UE and so on.

At operation 320, the model output is processed by the service node. For example, the service node may perform an action based on the model output. In an anomaly detection scenario, the service node may generate an alert if an anomaly is detected. In a traffic classification scenario, the service node may allocate a specified number and type of resources based on the type of traffic detected.

Method 300 is described above with respect to the training, deployment, and use of one ML algorithm for illustration purposes only. A plurality of ML algorithms may be trained, deployed, and used contemporaneously. Multiple iterations of method 300, or at least portions of method 300, may be performed in parallel for the different ML algorithms. For example, one ML algorithm may be for dynamic network slicing management, another ML algorithm for anomaly detection, and another one for traffic classification, and so on.

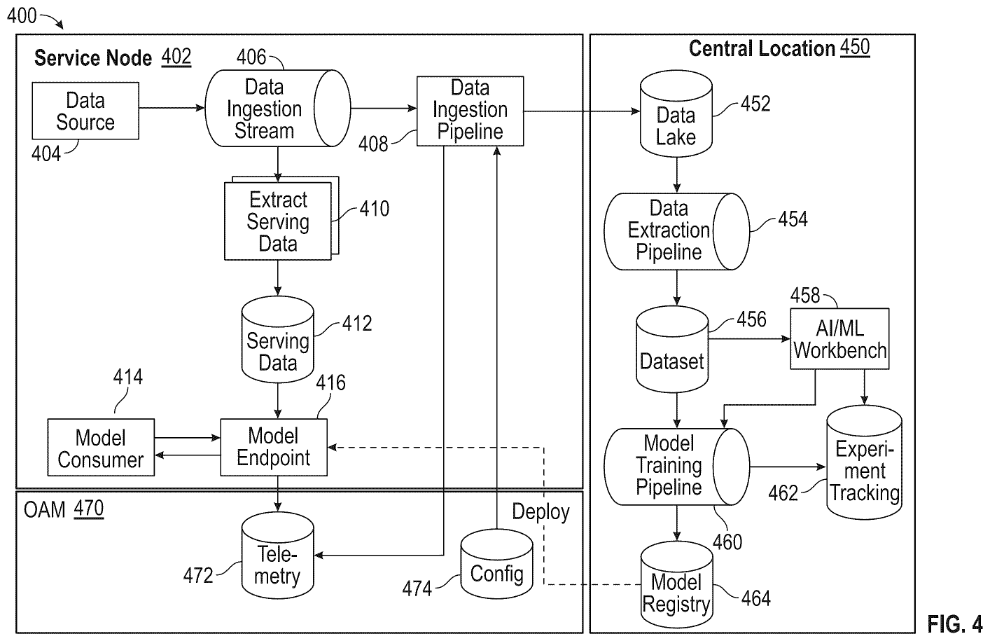

FIG. 4 shows a distributed AI/ML framework 400 designed to facilitate efficient data processing, model training, and deployment across a networked environment, in accordance with some embodiments of the present disclosure. The framework 400 may be distributed across one or more service nodes 402, a central location 450, and Operations, Administration, and Maintenance (OAM) 470. This framework 400 is structured to handle data from multiple sources, process the data, utilize the processed data for ML model training, deployment of the trained ML model, and utilizing the deployed ML model.

The service node 402 includes a data source 404. The data source 404 may include one or more gateway components. The gateway components may include different network functions, such as AMF, SMF, UPF. The data source 404 may include event hubs and batch uploads, which generate or publish events, such as mobility events, session events, data events, etc. For example, the data source 404 may include gateway components deployed at edge locations (service node 402), such as Kubernetes applications.

The data source 404 is coupled to a data ingestion stream 406. The data ingestion stream 406 may include a queue of the generated events. The data ingestion stream 406 may be provided as a streaming interface to ingest events generated by the data source 404. The ingested events may be organized as an event stream.

A data ingestion pipeline 408 is coupled to the data ingestion stream 406. The data ingestion pipeline 408 may process and prepare the data for transmission to the central location 450. The data ingestion pipeline 408 may be provided as one more computation tasks of a cloud processing platform. The data ingestion pipeline 408 may perform processing operations, such as filtering, aggregating, and sampling. For example, ingested data may include hundreds of mobility events collected during a session. Transmitting all mobility events to the central location 150 may be cumbersome and consume significant bandwidth. Therefore, a portion of the mobility events, such as 10%, may be sampled by the data ingestion pipeline 408. The sampled events may undergo other processing, such as removal or masking of sensitive information.

The data ingestion pipeline 408 may transmit the processed data to the central location 450. In some examples, the data may be transported securely over HTTPS/TLS over the internet.

The received data from the service node 402 is stored in a data lake 452 in the central location 450. The data lake 452 may be a centralized repository that stores large volumes of raw data from the various service nodes. The collected data include raw data from the various sources and stored in a centralized repository in structured, semi-structured, or unstructured format. The collected data from the different locations may be partitioned by customer, deployment, and namespace and stored in the data lake 452.

A data extraction pipeline 454 may extract relevant data to train the particular ML model. As mentioned above, the collected data include raw data from the different sources. Training a ML model with all of the collected data would consume significant resources, such as processing resources and time, and may not lead to an accurate ML model. Thus, relevant data for the particular ML model may be extracted for ML model training to conserve resources and increasing accuracy of the ML model. For example, data extracted for an anomaly detection model may be different than the data extracted for a traffic-classification model. The extracted data may be customized for the corresponding model. The extracted data may be stored in a dataset 456. An AI/ML workbench 458, model training pipeline 460, and experiment tracking 462 may train the ML model. The AI/ML workbench 458 may serve as a platform for data scientists and engineers to explore data, develop models, and conduct experiments. The model training pipeline 460 may handle the training of machine learning models using the prepared datasets 456, while experiment tracking 462 may monitor the performance and outcomes of various training runs.

The trained model is stored and registered in model registry 464. The trained model may be packed as serving endpoint containers. The ML model may be deployed in the service node 402. The model registry 464 may store different types of models that have been trained at the central location. The registered model may then be deployed at the different distributed locations (e.g., service nodes). For example, the updated or newer version of the model may be transmitted and installed at the distributed locations.

Referring back to the service node 402, once the data is ingested, the extract serving data 410 component extracts relevant data for immediate use, storing the information in the serving data DB 412. This serving data DB 412 serves as a repository for data that is actively used by the model endpoint 416, which is the deployed model from the central location 450. The model endpoint 416 also interfaces with a model consumer 414. The model consumer 414 may be an application or service (e.g., anomaly detection, traffic classifier) and utilize the predictions or outputs generated by the model endpoint 416, integrating these results into applications or services.

The OAM 470 may be used to oversee the entire framework, for example the performance of the model endpoint 416. The OAM 570 may collect telemetry information 472. OAM 470 may collect telemetry from serving containers like model performance, data skew, model drift, etc. These telemetries may be used to trigger model training pipeline 460 as appropriate. A configuration database 474 may store configuration settings. The configuration settings may include settings for the data ingestion pipeline 408, such as which data to filter, aggregate, and/or sample. Overall, this distributed AI/ML framework 400 is designed to optimize data processing and model deployment, providing a scalable and efficient solution for modern data-driven applications.

As mentioned above, the data lake 452 may store data from the different service nodes in a curated multi-tenant format. The collected data from the different locations may be partitioned by customer, deployment, and namespace. For example, each customer may be assigned with a resource group.

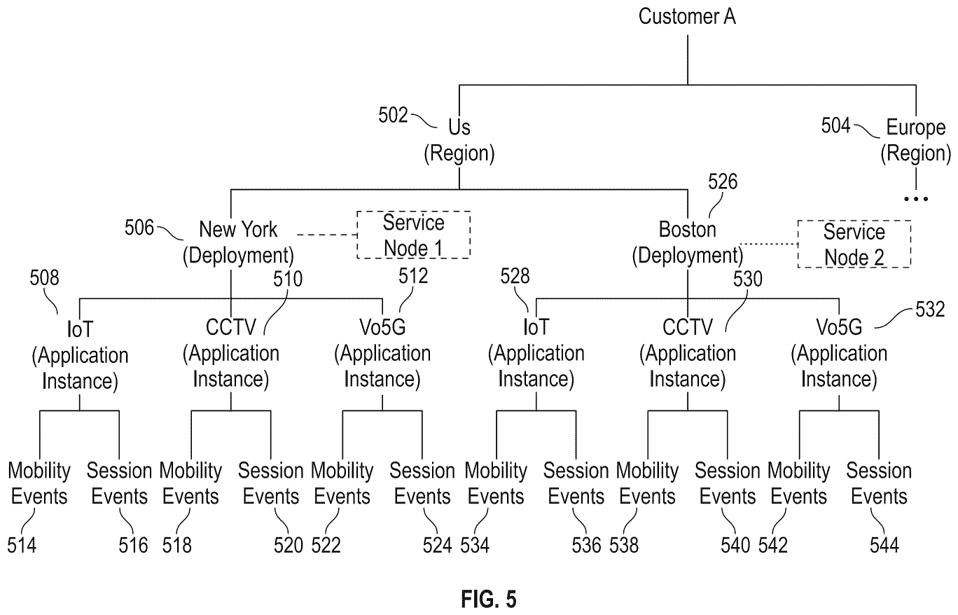

FIG. 5 shows an example of an organization structure of data stored in a data lake at a central location, in accordance with some embodiments of the present disclosure. The data shown in FIG. 5 is for one customer, which may be a retail provider in this example. As shown, the data is organized and stored in a hierarchical structure. Customer A's data is first organized by regions, such as US region 502 and Europe region 504. Details of the Europe region 504 are not shown for brevity, and the organization structure of the data in the Europe region 504 may be the same as or similar to the US region 502, which is described and shown in more detail.

Under the US region 502, the data is organized by different deployments, such as a New York deployment 506 and Boston deployment 526. Under the New York deployment 506 the data is organized by applications, such as IoT application 508, CCTV application 510, and Voice over 5G (Vo5G) application 512. Each application includes the events. For example, IoT application 508 includes mobility events 514 and session events 516. CCTV application 510 includes mobility events 518 and session events 520. Vo5G application 512 includes mobility events 522 and session events 524. Other events may be included, such as data events.

Likewise, the Boston deployment 526 includes an IoT application 528, CCTV application 530, and Vo5G application 532. Each application includes the events. For example, IoT application 528 includes mobility events 534 and session events 536. CCTV application 530 includes mobility events 538 and session events 540. Vo5G application 532 includes mobility events 542 and session events 544.

The AI/ML framework described herein can be used in different use cases. The use cases may include different applications or services, such as dynamic network slicing management, anomaly detection, traffic classification, mobile network paging optimization, TAL optimization, DRX silence period prediction, UE radio context optimization, handover optimization, intelligent application-edge selection, abnormal activity detection (e.g., for IoT), and efficient microservice resource management.

For example, the telecom industry generates massive amounts of telemetry data from networks, including performance counters, traffic metrics, and equipment logs. Accurate forecasting and anomaly detection in this data can be important for ensuring network reliability, minimizing downtime, and enhancing customer experience. The AI/ML framework can enable building scalable and efficient models tailored to telecom network telemetry, leveraging the temporal nature of the data for both predictive insights and fault detection.

The AI/ML framework may utilize statistics machine learning for predictive analytics and anomaly detection in telemetry datasets. The AI/ML framework may utilize metrics from mobility, session and UPF along with common metrics like memory usage, CPU utilization, etc. The AI/ML framework can be tailored for applications in IoT, industrial monitoring, and system diagnostics, enabling real-time insights and scalable deployment in production environments.

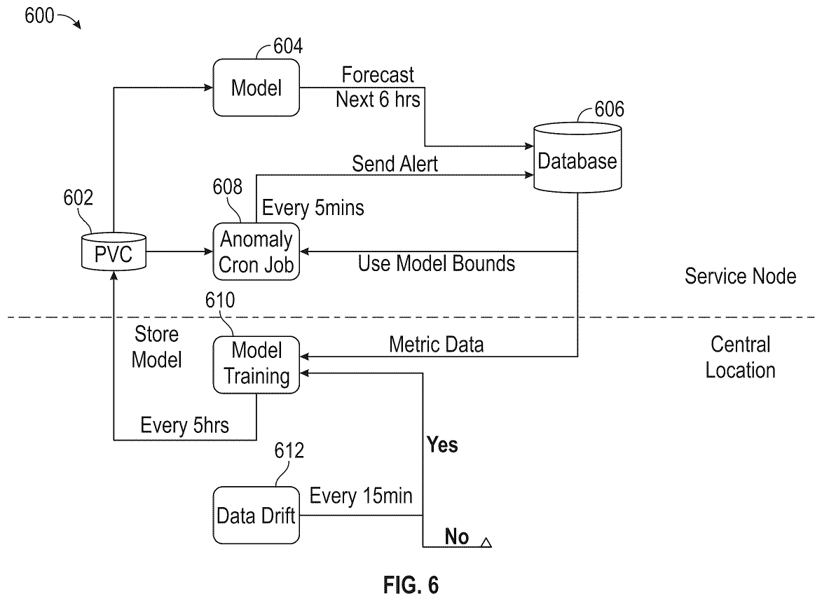

FIG. 6 shows an anomaly detection use case scenario using an AI/ML framework 600, in accordance with some embodiments of the present disclosure. A persistent storage, such as a persistent volume control (PVC) 602, may store and deploy a trained model 604. The storage of the model 604 in PVC 602 enables preserving the model 604 across different sessions making the model 604 accessible by other components.

The PVC may deploy the model 604 and input serving data for anomaly detection. The model 604 may generate a forecast of the network traffic for a specified time interval (e.g., next 6 hours) based on the serving data. Predictions made by the model 604 may be based on historical data and refined on an ongoing basis through the training process to enhance accuracy The forecast may be stored in database 606. For example, the lower and upper bounds of the forecast may be stored in the database 606.

The PVC 602 may also input current serving data (e.g., current session data) in an anomaly cron job 608, which may be a scheduled task that runs automatically at a set time or interval (e.g., every 5 minutes). The anomaly cron job 608 may also receive the forecast generated by the model 604, such as the lower and upper bounds of the forecast. The anomaly cron job 608 may compare the current conditions to the forecast, and if the current conditions differ by more than a specified threshold, the anomaly cron job 608 may generate an alert indicating the presence of an anomaly and notifying relevant systems or personnel of the detected anomaly. This alerting mechanism may enable prompt response of the detected anomaly and mitigation of potential issues within the network.

Metric data stored in the database 606 may be transmitted to central location for model training 610. A data drift component 612 may monitor data changes over time. The data drift component 612, for example, may check for any significant deviations in the data patter at 15-minute intervals. When data drift is detected, the model training 610 is activated. Model training 610 may then update the model to accommodate the new data patterns, ensuring that the model remains accurate and effective in detecting anomalies. The trained model may be stored in the PVC 602 with a data time tag for version control. This training process helps maintain the relevance and accuracy of the model in a dynamic data environment. The use of the AI/ML framework enhances the network's capability to adapt to changing data patterns and maintain high levels of accuracy in anomaly detection.

Next, another use case scenario of traffic classification is discussed. Network traffic is rapidly evolving over time make network management more difficult. For example, new apps and new app versions can be continuously deployed and introduce drift in traffic. Thus, conventional solutions (even conventional ML based approaches) may not scale well. Collecting large, labeled network-traffic datasets is a cumbersome and time-consuming process. In fact, capturing network-traffic traces, splitting them in traffic objects and associating labels to them, often requires dedicated setups and introduces user-privacy and business-sensitivity issues.

Furthermore, because most of the network traffic is being encrypted, the traditional deep-packet-inspecting (DPI) solutions are becoming obsolete. Traffic classification using the AI/ML framework described herein leverages advanced ML techniques to accurately categorize network traffic, including encrypted traffic, which traditional DPI methods struggle to analyze. The framework employs a ML model to identify and generalize traffic patterns with high accuracy, even in the presence of novel or previously unseen traffic types. By continuously collecting data from production environments (e.g., service nodes) and utilizing a model evaluation pipeline, the framework ensures that the traffic classification models are regularly updated and optimized for performance. This approach not only enhances network security by enabling precise identification of traffic types but also optimizes quality of service by allowing network operators to prioritize and manage traffic based on real-time insights. The AI/ML framework's ability to adapt to evolving traffic patterns and integration with existing network infrastructure make AI/ML framework a robust solution for modern network management challenges.

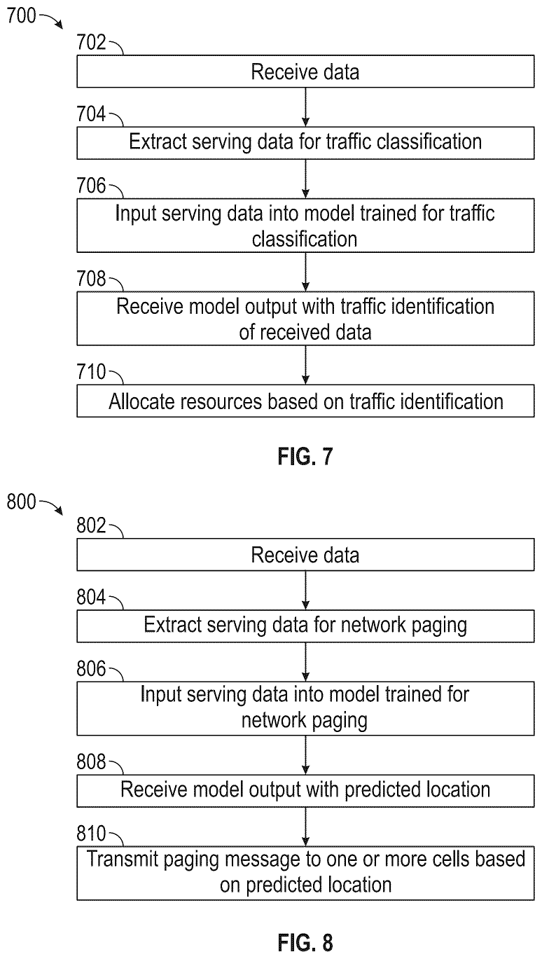

FIG. 7 is a flow diagram for a method 700 for traffic classification using the AI/ML framework, in accordance with some embodiments of the present disclosure. At operation 702, data is received at a service node. For traffic classification, data may be received from the UPF. The data may include encrypted and unencrypted traffic data.

At operation 704, serving data for traffic classification is extracted at the service node. For example, the serving data may include metadata such as packet sizes, flow statistics, and inter-arrival times of packets. The serving data may include an initial set of packets in an encrypted data session, such as the first 30 or 50 packets. The serving data may include the time duration of the initial set of packets. For example, the serving data may include the time between the transmission of the first and second packet, and between the transmission of the second packet and the third packet, and so on. The serving data may also include direction of the packets. For example, the direction may indicate that the packets are being transmitted from the network to the UE or vice versa. The serving data may also include the size of the packets. A digital signature may be generated based on metadata of the initial set of packets and may be used as serving data.

At operation 706, the serving data may be inputted into a ML model deployed in the service node. The ML model may have been trained for traffic classification at a central location using training data collected from various distributed locations as described herein. For example, the ML model may include a deep neural network that was trained using digital signatures of various traffic types using traffic-type labels. For example, video streaming may have a first type of digital signature while video gaming may have a second type of digital signature and social media websites may have a third type of digital signature and so on. The model may be periodically trained using real-time traffic data from the different service nodes, as described herein. New versions or updates to the model may be deployed at the service node as appropriate. For example, changes in traffic pattern may trigger deployment of new or updated model to the service nodes.

At operation 708, a model output is received with a traffic type identification. The model may generate a traffic type identification of the serving data. In some cases, the model may identify an unknown or new traffic type, which was not previously classified. The model may then classify the new traffic type. The data for the new traffic type is collected at the central location, and the model may be updated accordingly.

At operation 710, the service node allocates resources, such as network slices, based on the traffic identification. For example, the service node may allocate a certain amount and type of resources for video streaming traffic as compared to social media website traffic.

Network paging optimization is another use case scenario of the AI/ML framework as described herein. Network paging optimization using the AI/ML framework can be a transformative approach to managing the signaling overhead in mobile networks, particularly in LTE, 5G, and future 6G environments. Traditionally, when a UE is in an idle state, the location of the UE is known only at the Tracking Area (TA) level, which can lead to inefficient paging processes. For example, the network may broadcast a paging message in a large number of cells. The AI/ML framework addresses this problem by employing ML models to predict the most likely current location of a UE based on historical mobility patterns and real-time data. This predictive capability allows the network to target paging messages more accurately, reducing the need to broadcast messages across multiple cell towers and thereby conserving radio resources and minimizing UE power consumption. By optimizing the paging process, the framework significantly enhances network performance and user experience, particularly in scenarios where UEs frequently transition between idle and active states.

FIG. 8 is a flow diagram for a method 800 for network paging optimization using the AI/ML framework, in accordance with some embodiments of the present disclosure. At operation 802, data is received at a service node. For network paging optimization, data may be received from the MME and AMF. The data may include mobility events and session events.

At operation 804, serving data for network paging optimization is extracted at the service node. For example, the serving data may include historical mobility event information of the UE. The serving data may include the time and other information that can impact the mobility of the UE. For example, previous location of UE received in various signaling messages may be extracted and used to predict the probable next location.

At operation 806, the serving data may be inputted into a ML model deployed in the service node. The ML model may have been trained for predicting UE location using training data collected from various distributed locations as described herein. For example, the ML model may be a deep neural network that was trained using historical mobility information. The model may be periodically trained using real-time mobility data from the different service nodes, as described herein. New versions or updates to the model may be deployed at the service node as appropriate. For example, changes in mobility pattern may trigger deployment of new or updated model to the service nodes.

At operation 808, a model output is received with a predicted location of the UE based on the inputted serving data. The predicted location may include a particular cell or a set of cells.

At operation 810, the service node may transmit a paging message to the UE based on the predicted location. For example, the service node may transmit a paging message using a cell tower in the predicted cell or using a set of cell towers corresponding to the predicted set of cells.

The AI/ML framework's ability to dynamically learn and adapt to changing network conditions increases the effectiveness in network paging optimization. The framework can continuously ingest data from network events, such as mobility and session events, and uses this data to train and refine its predictive models at the central location, which are then deployed at the service nodes. These models can identify patterns and trends in UE movement, allowing the network to anticipate where a UE is likely to be located when it needs to be paged. This proactive approach not only reduces the signaling load on the network but also decreases the latency associated with establishing connections, which is especially important for applications requiring low latency and high reliability. Furthermore, the integration of the AI/ML framework with existing network infrastructure ensures that the ML models can be deployed seamlessly, providing a scalable solution that can evolve alongside advancements in mobile network technology.

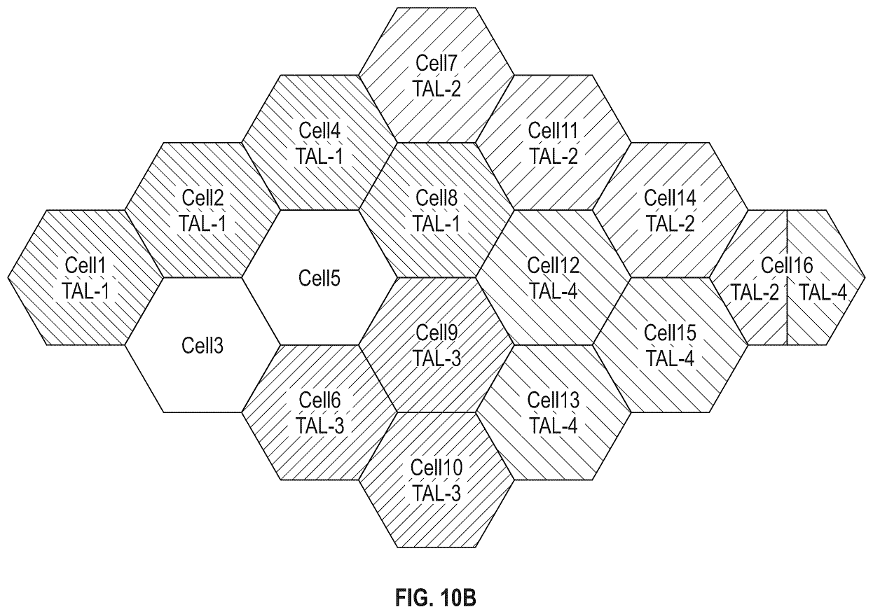

TAL optimization is another use case scenario of the AI/ML framework as described herein. In communication networks, a Tracking Area (TA) is a logical grouping of cells UE can move freely without updating its location. TALs are lists of Tas that a UE can traverse without triggering a location update. The TALs, in conventional systems, typically are generic and static lists clustering nearby cells without taking into account historical mobility patterns. FIG. 10A shows an example of static Tracking Area Lists. Here, TAL-1 includes cells 1, 2, 3, and 5. TAL-2 includes cells 4, 7, 8, and 11. TAL-3 includes cells 6, 9, 10, and 13. TAL-4 includes cells 12, 14, 15, and 16. These TALs may be used for all UEs without any customization or optimization based on the particular travel patterns of the UEs. In accurate TALs can lead to frequent location updates, which can lead to a ping-pong effect and signaling storms degrading network performance.

TAL optimization using the AI/ML framework can address the challenges of managing signaling overhead in mobile networks. The AI/ML framework can address these issues by employing ML models to optimize the configuration of TALs. By analyzing historical mobility patterns and real-time data, the framework can generate the most efficient TAL configuration for each UE, balancing the trade-off between paging overhead and location update overhead. This optimization can reduce unnecessary signaling, conserve network resources, and enhance overall network efficiency.

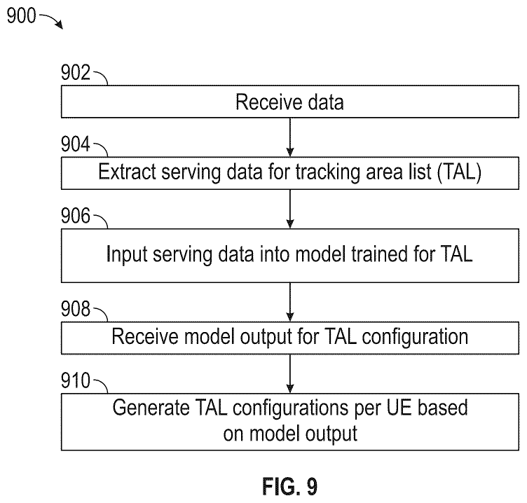

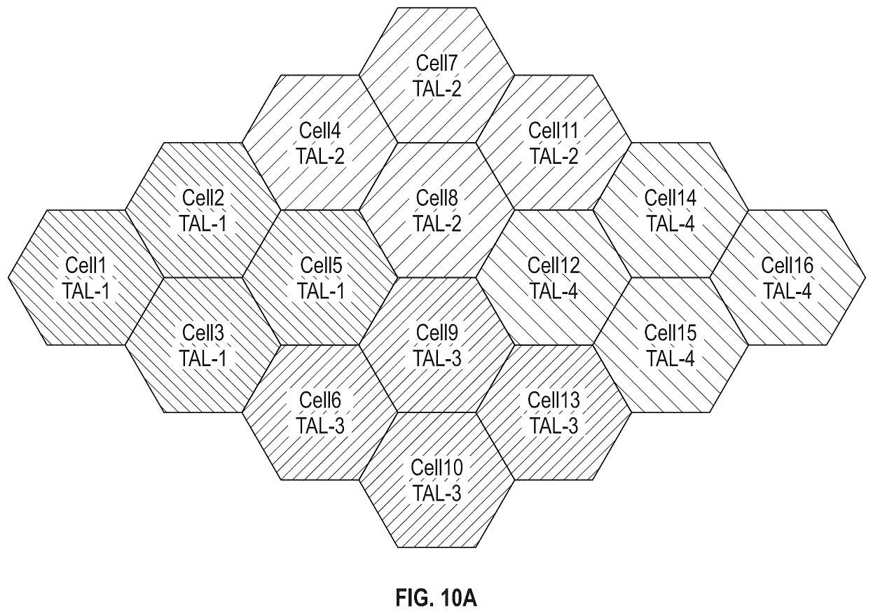

FIG. 9 is a flow diagram for a method 900 for TAL optimization using the AI/ML framework, in accordance with some embodiments of the present disclosure. At operation 902, data is received at a service node. For TAL optimization, data may be received from the MME and AMF. The data may include mobility events and session events.

At operation 904, serving data for network paging optimization is extracted at the service node. For example, the serving data may include historical mobility event information of the UE. The serving data may include the time and other information that can impact the mobility of the UE. The serving data may include UE past location trails based on events and data received from the MME and AMF.

At operation 906, the serving data may be inputted into a ML model deployed in the service node. The ML model may have been trained for generating TALs customized for UEs using training data collected from various distributed locations as described herein. For example, the ML model may be a deep neural network that was trained using historical mobility information. The model may be periodically trained using real-time mobility data from the different service nodes, as described herein. New versions or updates to the model may be deployed at the service node as appropriate. For example, changes in mobility pattern may trigger deployment of new or updated model to the service nodes.

At operation 908, a model output is received. The model output may include information for TAL configuration for the UE. For the example, the model output may include a predicted mobility pattern of the UE based on the inputted serving data. The predicted mobility pattern may include a set of cells.

At operation 910, the service node may generate a TAL configuration for the UE based on the model output. For example, generate a TAL customized for the UE based on the predicted mobility pattern, such as including the set of cells in the predicted mobility pattern.

FIG. 10B shows an example of optimized TAL configurations generated using the AI/ML framework, in accordance with some embodiments of the present disclosure. Here, the TALs are not generic, static lists, but customized list for UEs that have been optimized based on the predicted mobility patterns by the AI/ML framework. Here, TAL-1 corresponds to a customized TAL for UE1. TAL-1 includes cells 1, 2, 4, and 8. TAL-2 corresponds to a customized TAL for UE2. TAL-2 includes cells 7, 11, 14, and 16. TAL-3 corresponds to a customized TAL for UE3. TAL-3 incudes cells 6, 9, and 10. TAL-4 corresponds to a customized TAL for UE4. TAL-4 includes cells 12, 13, 15, and 16.

The AI/ML framework's ability to adapt to dynamic network conditions can improve TAL optimization and thus improving network performance. By continuously collecting and analyzing data on UE movements and network performance, the framework refines its predictive models to accommodate changes in user behavior and network topology. This allows the framework to provide real-time recommendations for TAL configurations that minimize signaling overhead while maintaining optimal network performance. The integration of AI-driven insights into TAL management allows the network to respond swiftly to changes in user mobility patterns, reducing latency and improving the quality of service for end-users. Additionally, the framework's scalability and compatibility with existing network infrastructure provides robustness and can evolve alongside technological advancements and increasing demands for connectivity.

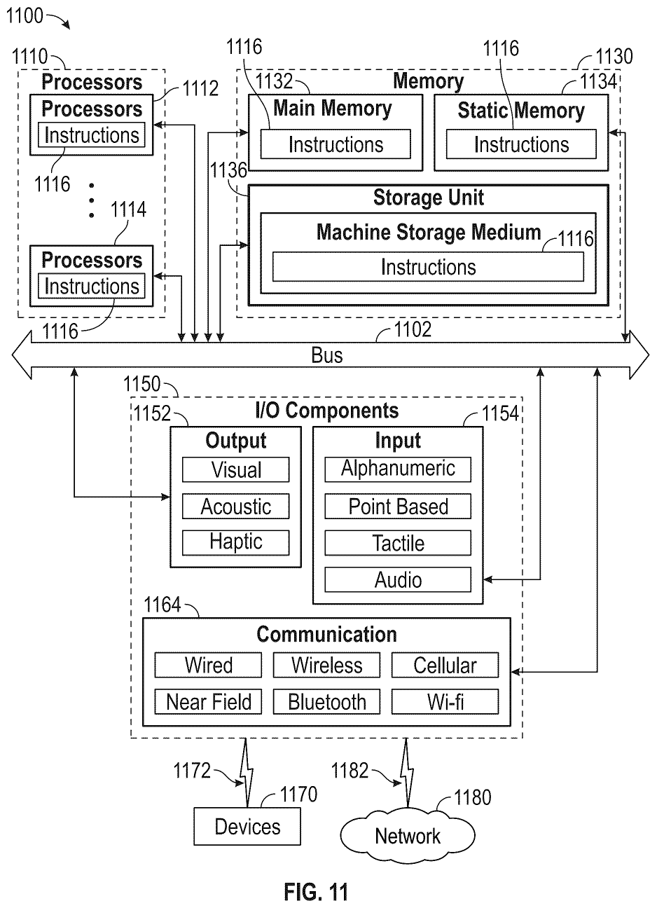

FIG. 11 illustrates a representation of a machine 1100 in the form of a computer system within which a set of instructions may be executed for causing the machine 1100 to perform any one or more of the methodologies and techniques discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute any one or more operations of any one or more of the methods described herein. As another example, the instructions 1116 may cause the machine 1100 to implement portions of the data flows described herein. In this way, the instructions 1116 transform a general, non-programmed machine into a particular machine 1100 (e.g., service nodes, orchestrator nodes, edge managers, etc.) that is specially configured to carry out any one of the described and illustrated functions in the manner described herein.

In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 includes processors 1110, memory 1130, and input/output (I/O) components 1150 configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors (sometimes referred to as “cores”) that may execute instructions 1116 contemporaneously. Although FIG. 11 shows multiple processors 1110, the machine 1100 may include a single processor with a single core, a single processor with multiple cores (e.g., a multi-core processor), multiple processors with a single core, multiple processors with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 include components to receive input, provide output, produce output, transmit information, exchange information, capture measurements, and so on. The specific I/O components 1150 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, and other communication components to provide communication via other modalities. The devices 1170 may be another machine or any of a wide variety of peripheral devices (e.g., a peripheral device coupled via a universal serial bus (USB)). For example, as noted above, the machine 1100 may correspond to any one of the service nodes, edge managers, orchestrator nodes, etc., described herein, and the devices 1170 may include any other of these systems and devices.

The various memories (e.g., 1130, 1132, 1134, and/or memory of the processor(s) 1110 and/or the storage unit 1136) may store one or more sets of instructions 1116 and data structures (e.g., software) embodying or utilized by any one or more of the methodologies or functions described herein. These instructions 1116, when executed by the processor(s) 1110, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network such as those defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A method for operating a communication network, the method comprising:
receiving, by a service node of the communication network, event data from one or more gateway components at the service node;
processing the event data to generate processed data for transmission to a central location of the communication network, the processing comprising removing sensitive information and sampling the event data;
transmitting, by the service node, the processed data to a central location, wherein the central location is configured to receive data from a plurality of other service nodes and to train a machine-learning (ML) model using the processed data and received data from the plurality of other service nodes, and wherein the central location is configured to deploy a ML model endpoint to the service node;
extracting serving data from the event data;
inputting the serving data into the ML model endpoint deployed at the service node from the central location;
receiving a model output from the ML model endpoint; and
processing the model output to perform an action at the service node.

2. The method of claim 1, wherein the model output comprises a forecast of network traffic comprising an upper bound and a lower bound of the forecast, wherein the method further comprising:
performing a scheduled task to determine current network conditions;
comparing the current network conditions to the upper bound and the lower bound of the forecast;
in an event the current network conditions are outside the upper bound and the lower bound of the forecast, detecting an anomaly; and
generating an alert based on the detected anomaly.

3. The method of claim 1, wherein the model output comprises traffic identification of the event data.

4. The method of claim 3, wherein the event data is encrypted, and wherein the serving data comprises metadata for an initial set of packets in a data session, wherein the metadata comprises at least one of packet sizes, flow statistics, or inter-arrival times of packets.

5. The method of claim 1, wherein the model output comprises a predicted location of a user equipment (UE), and wherein the action comprises transmitting a paging message from one or more cell towers based on the prediction location.

6. The method of claim 1, wherein the model output comprises a mobility pattern of a UE, and wherein the action comprises generating a customized tracking area list (TAL) for the UE based on the mobility pattern.

7. The method of claim 1, further comprising:
transmitting telemetry information related to performance of the deployed model endpoint, wherein the telemetry information is used to trigger model training at the central location.

8. A system comprising:
at least one hardware processor; and
at least one memory storing instructions that, when executed by the at least one hardware processor, cause the at least one hardware processor to perform operations comprising:
receiving, by a service node of a communication network, event data from one or more gateway components at the service node;
processing the event data to generate processed data for transmission to a central location of the communication network, the processing comprising removing sensitive information and sampling the event data;
transmitting, by the service node, the processed data to a central location, wherein the central location is configured to receive data from a plurality of other service nodes and to train a machine-learning (ML) model using the processed data and received data from the plurality of other service nodes, and wherein the central location is configured to deploy a ML model endpoint to the service node;
extracting serving data from the event data;
inputting the serving data into the ML model endpoint deployed at the service node from the central location;
receiving a model output from the ML model endpoint; and
processing the model output to perform an action at the service node.

9. The system of claim 8, wherein the model output comprises a forecast of network traffic comprising an upper bound and a lower bound of the forecast, wherein the operations further comprising:
performing a scheduled task to determine current network conditions;
comparing the current network conditions to the upper bound and the lower bound of the forecast;
in an event the current network conditions are outside the upper bound and the lower bound of the forecast, detecting an anomaly; and
generating an alert based on the detected anomaly.

10. The system of claim 8, wherein the model output comprises traffic identification of the event data.

11. The system of claim 10, wherein the event data is encrypted, and wherein the serving data comprises metadata for an initial set of packets in a data session, wherein the metadata comprises at least one of packet sizes, flow statistics, or inter-arrival times of packets.

12. The system of claim 8, wherein the model output comprises a predicted location of a user equipment (UE), and wherein the action comprises transmitting a paging message from one or more cell towers based on the prediction location.

13. The system of claim 8, wherein the model output comprises a mobility pattern of a UE, and wherein the action comprises generating a customized tracking area list (TAL) for the UE based on the mobility pattern.

14. The system of claim 8, the operations further comprising:
transmitting telemetry information related to performance of the deployed model endpoint, wherein the telemetry information is used to trigger model training at the central location.

15. A machine-storage medium embodying instructions that, when executed by a machine, cause the machine to perform operations comprising:
receiving, by a service node of a communication network, event data from one or more gateway components at the service node;
processing the event data to generate processed data for transmission to a central location of the communication network, the processing comprising removing sensitive information and sampling the event data;
transmitting, by the service node, the processed data to a central location, wherein the central location is configured to receive data from a plurality of other service nodes and to train a machine-learning (ML) model using the processed data and received data from the plurality of other service nodes, and wherein the central location is configured to deploy a ML model endpoint to the service node;
extracting serving data from the event data;
inputting the serving data into the ML model endpoint deployed at the service node from the central location;
receiving a model output from the ML model endpoint; and
processing the model output to perform an action at the service node.

16. The machine-storage medium of claim 15, wherein the model output comprises a forecast of network traffic comprising an upper bound and a lower bound of the forecast, wherein the operations further comprising:
performing a scheduled task to determine current network conditions;
comparing the current network conditions to the upper bound and the lower bound of the forecast;
in an event the current network conditions are outside the upper bound and the lower bound of the forecast, detecting an anomaly; and
generating an alert based on the detected anomaly.

17. The machine-storage medium of claim 15, wherein the model output comprises traffic identification of the event data.

18. The machine-storage medium of claim 17, wherein the event data is encrypted, and wherein the serving data comprises metadata for an initial set of packets in a data session, wherein the metadata comprises at least one of packet sizes, flow statistics, or inter-arrival times of packets.

19. The machine-storage medium of claim 15, wherein the model output comprises a predicted location of a user equipment (UE), and wherein the action comprises transmitting a paging message from one or more cell towers based on the prediction location.

20. The machine-storage medium of claim 15, wherein the model output comprises a mobility pattern of a UE, and wherein the action comprises generating a customized tracking area list (TAL) for the UE based on the mobility pattern.
